(19) United States
(12) Patent Application Publication
(10) Pub. No.: US 2026/0295368 A1
(43) Pub. Date: Oct. 1, 2026

(54) Ski device drivetrain and system

(71) Applicant: Gurnoor SOOCH, Walpole, MA (US)

(72) Inventors: Gurnoor Sooch, Walpole, MA (US); Constantino Camerano Spelta Rapini, Glen Head, NY (US); Soham Dey, Boston, MA (US); Ryan Marie, North Andover, MA (US); Waleed Khan, Flushing, NY (US)

(21) Appl. No.: 19/477,612

(22) PCT Filed: Apr. 24, 2024
(86) PCT No.: PCT/US2024/026101

§ 371 Date: Oct. 22, 2025

Related U.S. Application Data
(60) Provisional application No. 63/498,951, filed on Apr. 28, 2023.

(51) Int. Cl. A63C 5/035

(52) U.S. Cl. CPC A63C 5/035; A63C 2203/12; A63C 2203/18; A63C 2203/22

(57) ABSTRACT

Drivetrains and systems for operating a ski device. The drive train includes a track configured to contact a ground surface, a propulsion device configured to operate the track to at least propel the ski device, a static component configured to be operably connected to the ski device, and a dynamic component pivotally attached to the static component and configured to apply a variable force on the endless track to provide variable traction with the ground surface.

### CROSS-REFERENCE TO RELATED APPLICATIONS

The present application claims the benefit of and priority to co-pending United States provisional application. no. 63/498,951, filed on Apr. 28, 2023, the entire disclosure of which is incorporated by reference as if set forth in its entirety herein.

### TECHNICAL FIELD

Embodiments described herein generally relate to snow equipment and, more particularly but not exclusively, to ski devices and other devices for maneuvering in snowy or icy environments.

### BACKGROUND

Traditional ski devices tend to be bulky and otherwise awkward to transport or use over long distances. Their use requires a great deal of physical effort, which limits the number of people who can use them over long or flat distances.

Motorized skis have been developed in which traditional skis are fitted with a so-called “ski tow.” These devices are generally mounted to a portion of the ski and include a motor-driven belt attached to the ski. A track engages with snow for transporting the skier, and the skier's weight packs the snow so the track engages the snow and provide a forward thrust. However, these existing devices are large, complex, and bulky.

A need exists, therefore, for simpler and more efficient ski devices.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a drivetrain for a ski device. The drivetrain includes a track configured to contact a ground surface; a propulsion device configured to operate the track to at least propel the ski device, a static component configured to be operably connected to the ski device; and a dynamic component pivotally attached to the static component and configured to apply a variable force on the track to provide variable traction with the ground surface.

In some embodiments, the dynamic component is biased against the ground surface.

In some embodiments, the drivetrain further includes a suspension component operably connected between the static component and the dynamic component. In some embodiments, the drivetrain further includes an adjustment mechanism to adjust the suspension component to vary an amount of suspension of the drivetrain.

In some embodiments, the drivetrain further includes a controller configured to receive a signal, and modulate an output from the propulsion device to control the track. In some embodiments, the signal is received wirelessly. In some embodiments, the signal is received via a wired connection. In some embodiments, the drivetrain further includes at least one sensor configured to gather environmental data, and the controller is further configured to modulate the output from the propulsion device based on the environmental data.

In some embodiments, the drivetrain further includes a release mechanism to enable the drivetrain to be removably attached to the ski device.

In some embodiments, the drivetrain is operational while propelling the ski device, and idle or in a brake mode when the ski device is not propelled.

In some embodiments, the drivetrain further includes at least two wheels, wherein at least one of the at least two wheels is in operable connectivity with the track and the propulsion device. In some embodiments, power from the propulsion device is transferred to at least one driving wheel using a belt or chain drive, a hub motor within the wheel, a gear-driven system, or a directly-driven axle.

In some embodiments, the drivetrain further includes a motor, wherein the controller includes an Electronic Speed Controller or a motor controller.

In some embodiments, the track further includes a hyfax subsystem.

According to another aspect, embodiments relate to a system for operating a ski device. The system includes at least one sensor configured to gather environmental data associated with the ski device; a drivetrain operably connected with the ski device and configured to propel the ski device; and a processor executing instructions stored on memory and configured to analyze the environmental data and control the drivetrain to propel or brake the ski device based on the analysis of the environmental data.

In some embodiments, the drivetrain includes a static component operably connected to the ski device and a dynamic component pivotally attached to the static component and configured to apply a variable force on the track to provide variable traction with a ground surface. In some embodiments, the dynamic component is biased against the ground surface.

In some embodiments, the drivetrain further includes a suspension component operably connected between the static component and the dynamic component. In some embodiments, the drivetrain further includes an adjustment mechanism to adjust the suspension component to control an amount of suspension.

In some embodiments, the drivetrain further includes at least two wheels, wherein at least one of the at least two wheels is in operable connectivity with the track and a propulsion device.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a side view of a drivetrain operably connected to a ski device in accordance with one embodiment;

FIG. 2 illustrates a top view of the drivetrain and the ski device of FIG. 1 in accordance with one embodiment;

FIG. 3 illustrates a bottom view of the drivetrain and the ski device of FIG. 1 in accordance with one embodiment;

FIG. 4 illustrates a side view of the drivetrain of FIG. 1 in accordance with one embodiment;

FIG. 5 illustrates a perspective view of the drivetrain of FIG. 1 in accordance with one embodiment;

FIG. 6 illustrates a side view of a drivetrain in accordance with another embodiment;

FIG. 7 illustrates a side view of the drivetrain of FIG. 6 operably connected to a ski device with the enclosure removed in accordance with one embodiment; and

FIG. 8 illustrates a diagram of a system for operating a ski device in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The embodiments herein provide novel drivetrains and systems for ski devices. In the context of the present application, the term “ski device” and variations thereof may refer to skis of various sizes and types, such as cross-country skis, touring skis, racing skis, freestyle skis, carving skis, or any other type of ski device whether available now or invented hereafter. “Ski device” may also refer to other types of snow sporting equipment such as snowboards, snow skates, or any other type of devices for maneuvering over snow-like or icy environments.

The drivetrain described herein may include an endless track configured to contact a ground surface below or otherwise adjacent to the ski device, and a propulsion device such as a motor to operate the endless track to at least propel the ski device. The drivetrain may also include a static component configured to be operably connected to the ski device, and a dynamic component pivotally attached to the static component and configured to apply a variable force on the endless track to provide variable traction with the ground surface.

The drivetrain may be longitudinally aligned with the ski device and may partially rest on the ski device surface. A suspension component may be positioned between the static and dynamic components to provide an amount of suspension or a damping effect for the ski device. The drivetrain may be operational while propelling the ski device, and idle or braking when the ski device is not being propelled.

The drivetrain in accordance with the described embodiments achieves a smaller size and reduced weight compared to existing devices, while also incorporating a propulsion device. This allows the ski device(s) described herein to provide users with an assisted snow travel experience without sacrificing transportability. This assistance is helpful for climbing mild to moderate hills as well as crossing long distances, thereby allowing greater enjoyment of the user's surrounding environment.

Compared to the heavier motorized snowmobiles, the drivetrains described herein have far less impact on the environment. The drivetrains described herein produce no carbon emissions, create very little heat, are nearly silent, and do not cause much deterioration to the surface on which it is traveling.

The drivetrains described herein may operate in a variety of environments. The surface or ground may be anything from a granular surface such as snow, dirt, mud, or sand to a more rigid surface such as ice or any other terrain. As such, it has the potential for use on cross-country ski trails or snowmobile trails as well as other pathways. Due to their quiet operation, the disclosed embodiments allow a user to easily receive auditory information from the surrounding environment. Additionally, the disclosed embodiments may be implemented in search-and-rescue applications since they do not affect nearby detection systems.

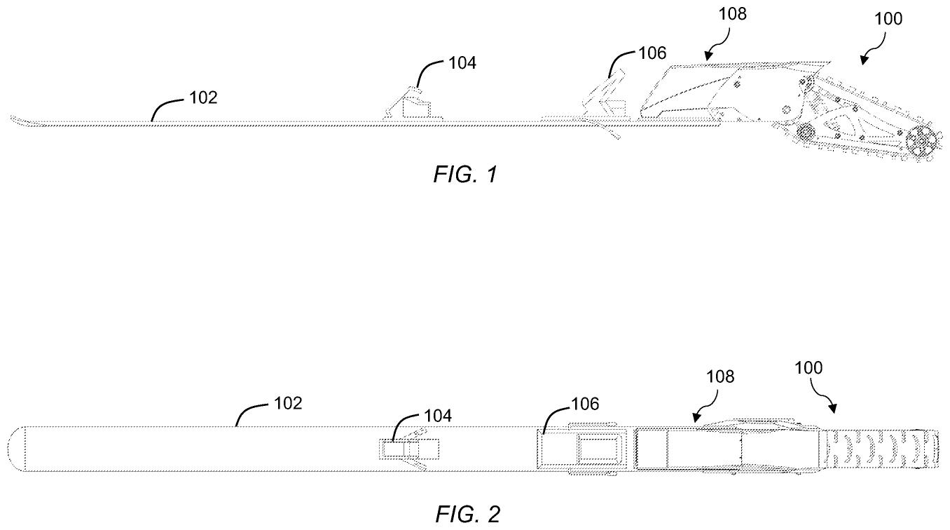

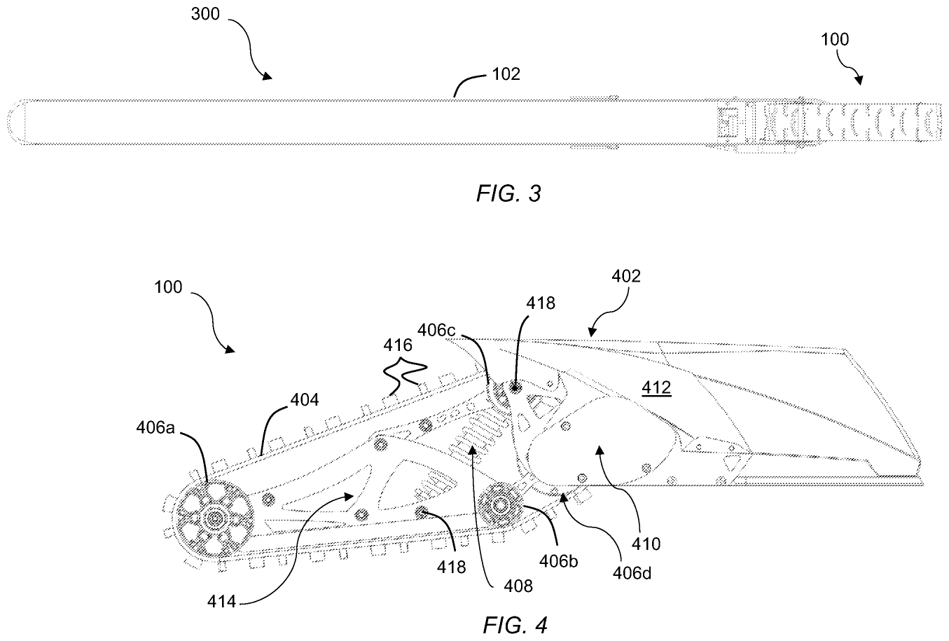

FIG. 1 illustrates a drivetrain 100 operably connected with a ski device 102 in accordance with one embodiment. FIG. 2 illustrates a top view of the drivetrain 100 and the ski device 102; FIG. 3, a bottom view.

As seen in FIGS. 1-3 the ski device 102 also includes a front binding 104 and a rear binding 106 for securing a user (not shown in FIG. 1), and a battery 108. The bindings 104 and 106 may include downhill bindings, Nordic bindings, touring bindings, custom bindings, or the like. In these embodiments, the drivetrain 100 is positioned toward the rear of the ski device 102.

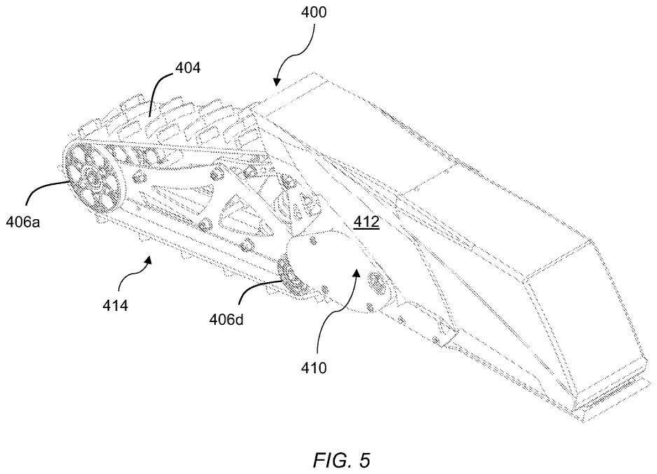

FIGS. 4 and 5 illustrate a side view and perspective view, respectively, of the drivetrain 100 of FIGS. 1-3 in accordance with one embodiment. The drivetrain 100 may include an, inter alia, an enclosure 402, track 404, and wheels 406a-d. The drivetrain 100 may also include a suspension 408, a propulsion device such as a motor 410, static component or subsection 412, and a dynamic component or subsection 414. The motor 410 may be positioned within the static component 412.

The track 404 may have an outer pattern with lugs 416, grooves, or paddles (for simplicity, “lugs”) to grip and pull through the snow or other type of ground surface, thereby propelling the ski device 102 and the user forward. The track 404 may be made of a variety of materials. For example, the track 404 may be constructed entirely from rubber; rubber reinforced with layers of flexible fabric or composite; or rubber with metal, ceramic, or even plastic reinforcement.

The track 404 may also have other materials on the outer lugs 416 to improve grip on a greater variety of surfaces or to improve wear resistance. For example, the track 404 may include stud components to improve grip on icy terrain. A track 404 may also be made of any other flexible material, such as a plastic or a rigid material with joints to allow the track 404 to flex around wheels 406a-d. Flexible tracks may also have joints to make them conform even better to the curvature of the wheels 406a-d.

On the inner side of the tracks 404, lugs or extrusions (not shown) may interface with one or more wheels 406a-d. The lugs may be made of a wide variety of material, e.g., the same material as the track 404, a metal, a plastic, or rubber. Although the track 404 may have lugs, the wheels 406a-d may also be made with lugs or teeth protruding from the main body of the wheel to interface with the track 404 with matching spaces or notches therein.

It may be possible to use both or neither method of driving the track 404. For example, the track 404 may have a flush or textured inner surface and leverage friction with the wheels 406a-d. This, however, would require the internal resistance of the track 404 to be greater than the external friction against the ground surface.

The track 404 may be removable from the drivetrain 100 for repair for replacement. For example, a user may remove a broken or damaged track and replace it with a new track. Additionally or alternatively, a user may change tracks based on the terrain type. If the user were attempting to ski over ice, they may use tracks with metal spikes to increase traction. The user may later swap that track out for a softer one that is better suited for travel over snow. One way the track could be removed is with a hatch door that is part of a rigid section of the drivetrain 100 or the enclosure 402.

The wheels 406a-d may be constructed using one or more of a variety of materials. In some embodiments, one or more of the wheels 406a-d may be formed from a metal such as steel, aluminum, titanium, or an alloy. Possible composites include, but are not limited to, carbon, natural, or glass fibers. One or more of the wheels 406a-d may be made of plastics such as Acrylonitrile Butadiene Styrene (ABS), Nylon, polyethylene terephthalate glycol (PETG), or others with a rigid or semi-rigid construction.

The wheels 406a-d may also employ a combination of materials such that certain portions of the wheel exhibit physical properties different from others. For example, the wheels 406a-d could use a composite, metal, or rigid interior structure with an outer layer of flexible material to reduce vibration. The wheels 406a-d may also have a hardened outer layer to reduce wear over time.

One or more of the wheels 406a-d may be configured to use a single axle. For this to adequately support the track 404, the face of the wheel in contact with the track 404 at a given moment must have adequate width. Alternatively, multiple wheels may be placed on one axle to provide additional support for the track 404.

Having multiple thinner wheels 406a-d running on one axle allows snow caught inside the track 404 to escape the drivetrain 100 through spaces between the wheels 406a-d. This may prevent jamming in the track 404 caused by snow or other substances that become wedged between the face of the wheel and the inside of the track 404. This may be particularly beneficial for the driving wheel, which relies on a relatively clean connection with the track 404. The set of multiple wheels 406a-d may require a method of constraining motion along the axle such that the wheels maintain adequate spacing from one another. Accordingly, a washer or space may separate two or more of the wheels on a single axle. One or more of the wheels 406a-d may also be mechanically secured using a coupler.

The drivetrain 100 may also include a propulsion device such as a motor 410 to drive one or more of the wheels 406a-d. The motor 410 may be powered by electricity (e.g., from an on-board battery) or may comprise a heat engine. In some embodiments, the propulsion device may be configured with in-wheel motors or with hub motors. In these embodiments, the propulsion device benefits from power characteristics of a direct drive motor system but with reduced weight and maintenance costs. Gears may be an alternative method of transferring power from the motor to the track 404.

In some embodiments, a motor 410 may drive one or more wheels 406a-d using a solid connection to the axle of the driving wheel(s). These embodiments may not require pulleys, belts, or belt-tensioning systems. The motor 410 may be controlled by an Electronic Speed Controller (ESC) or motor controller that translates commands from a processor (see FIG. 8 below) into actions to be performed by the motor 410. The controller may also be tasked with taking power from the battery and giving that power to the motor in controlled amounts. An ESC may also be used to allow the motor to idle freely or to brake which may involve a regenerative braking aspect. In some embodiments, a processor receives user input to convey to the drivetrain how to react to that input.

In some embodiments, one or more of the wheels 406a-d may be driven using pulleys or belts with a defined gear tooth ratio. The disclosed embodiments may also achieve different power characteristics based on changes in the gear ratio. For example, to increase the acceleration or top speed of the ski device 102, a driving wheel may be powered using different gear ratios.

A belt interacting with two or more pulleys may require a tensioning system including one or more static or dynamic elements. For example, a static tensioning system may include a fixed or manually adjustable roller positioned to apply a force on a pulley belt that is perpendicular to the direction of rotation.

A dynamic tensioning system may include a roller, bearing, or wheel that is supplemented by a spring or similar mechanism to allow a degree of adaptability in the amount of tension that is applied to the belt. Regardless of the tensioning methodology used, the belt should be wrapped tightly such that the teeth on the pully do not disengage from the teeth on the belt.

In some embodiments, the belts and pulleys of the drivetrain 100 may be replaced with chains and sprockets with similar tensioners as described above in conjunction with the static and dynamic tensioning systems. In some embodiments, the drivetrain 100 may implement or otherwise include a set of gears or a gearbox to transmit power. While there may not be a significant difference in performance between using a chain or a belt, there may be factors to consider based on noise, weight, and maintenance constraints. Using a belt-, gear-, or chain-driven system has the advantage that the motor can be kept further away from the tracks and the associated snow, water and other substances or debris resultant from operation.

Regardless of the configurations described above, keeping the motor or other components of a propulsion device in or otherwise shielded by the enclosure 402 may protect them from the environment and may prove advantageous in increasing component longevity. In the case of utilizing the enclosure 402 for protecting a motor, the motor axle may protrude from the enclosure 402 so that it may transfer power to the track 404.

The suspension 408 may provide a damping force on the ski device 102 during use. Specifically, the suspension 408 may apply an outward force on a rail, idler wheel, bearing assembly, or an entire structure so that the track 404 may be tensioned and biased against the surface below the ski device 102. The suspension 408 may comprise a spring and damper, air shock, a simple spring, a leaf spring, or any other flexible plastic, composite, or metal structure to allow the track 404 to bend and flex with the terrain, thereby increasing traction from the track 404.

The suspension 408 may be adjustable to allow for a harder or softer experience. This could be done with a screw-based system or other device that, when used, would increase or decrease the compression of a suspension spring. Providing a softer suspension could be ideal for a smoother ride on rough terrain, and a harder suspension could be ideal for smoother terrain such as ice to allow for increased traction. The adjustment in the suspension 408 may also help users of varying weight calibrate the ski device 102 for their comfort and ease of handling.

The ski device 102 may provide enough elasticity to act as a form of suspension in some situations. However, this may be insufficient on terrain that is exceedingly rough or hard. Accordingly, variable tension on the track 404 may be provided by having an idler wheel or rail or hyfax subsystem. The track tension could also be provided by a separate spring or be a derivative of the suspension 408 described above.

As seen in FIG. 4, the drivetrain 100 may be formed from a plurality of mechanical components and linkages. This internal structure may be made from plates of plastic, composite such as carbon fiber or fiberglass, or metal, or it may be made of beams or supports that are joined to form a rigid frame. Using beams to join or reinforce plates in parallel may create sturdier frames for the drivetrain 400.

As discussed above, these frames may form a static component 412 and a dynamic component 414. The static component 412 may be mounted to the ski device 102 as in FIGS. 1-3. The dynamic component 414 may be operably connected to the static component 412 but configured to move in response to external forces applied thereon by the suspension 408 or the ground surface on which the ski device 102 is moving.

Additionally, the suspension 408 may further include one or more linkages to allow the suspension 408 to apply force to an entire subsystem of components of the dynamic component 414. As seen in FIG. 4, the suspension 408 may be placed between the two components, wherein one side is affixed to the static component 412 and the other side is mounted to the dynamic component 414.

Using axles 418 to mount the two sides of the suspension allows it to pivot with the linkages mentioned above. Instead of linkages, the dynamic component 414 of the drivetrain 100 may also be pivotally attached to the static component 412 such that it is free to swing. Combining this mode of pivotal attachment with the suspension 408 would enable the ski device 102 to perform comparably to when the dynamic component 414 is mounted using linkages. As another alternative, the dynamic component 414 may be mounted on the static component 412 using rails, which may also perform comparably to the linkages.

The angle of the dynamic component 414 with respect to the static component 412 or the ski device 102 may vary. For example, a user may adjust this angle by adjusting the length of any arms or linkages that form or connect the static component 412 and the dynamic component 414.

The drivetrain 100 or components thereof may be removably secured to the ski device 102. A user may then use the ski device 102 as they would use a normal ski. The drivetrain 100 or components thereof may be removably secured to the ski device 102 via any one or more of rails, clips, hook-and-loop fasteners, or other fixture methods that can allow the drivetrain 100 to be detached from the ski device 102, such as by using screws, pins, or other mechanical means.

The battery or other components of a powertrain may also be removably secured to the ski device 102. For example, a user may remove the battery from the ski device 102 for charging, replacement, or the like. The battery or other components associated with a powertrain may be removably secured to the ski device 102 via any one or more of rails, clips, hook-and-loop fasteners, or other fixture methods that can allow the overall powertrain to be detached from the ski device 102, such as by using screws, pins, or other mechanical means.

These features may be useful situations such as if the battery died and the user is not close to a charging location. Accordingly, it may be beneficial for the user to remove the drivetrain 100 or battery from the ski device 102, and carry or store the drivetrain 100 or battery in a backpack.

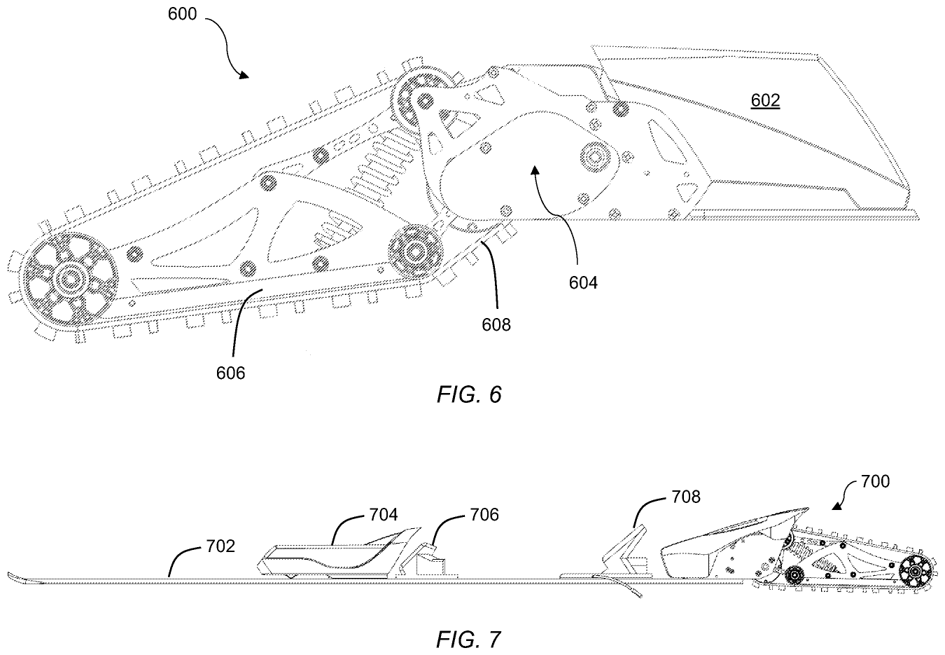

FIG. 6 illustrates a drivetrain 600 in accordance with another embodiment. The drivetrain 600 may be similar to the drivetrain 400 discussed previously. However, the drivetrain 600 is shown without an enclosure. FIG. 6 also illustrates a battery 602 that supplies power the motor 604. The drivetrain 600 also includes a rail or hyfax subsystem 606 for allowing the track 608 to apply force onto a ground surface along a much larger, linear contact area. Multiple rails or hyfax subsystems 606 may be disposed in parallel to each other to provide additional support to the track. One or more rails may also be paired with a smooth surface such as metal or low friction plastic to allow the track 608 to glide over it while still applying the required force onto the track 608.

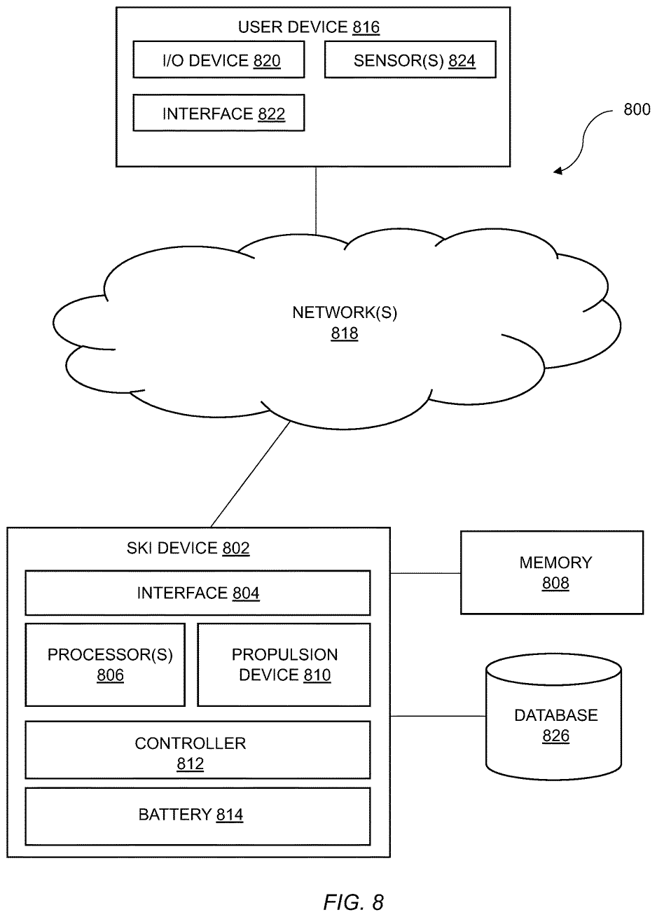

FIG. 7 illustrates a drivetrain 700 on a ski device 702 in accordance with one embodiment. The drivetrain 700 may be similar to the drivetrain 100 discussed previously. In this embodiment the battery 704 is placed toward the front of the ski device 702 and in front of the front binding 706 and the rear binding 708. This arrangement may be beneficial in providing additional traction to the drivetrain 700 by positioning the center of mass of the user closer to the track.

FIG. 8 illustrates a system 800 for operating a ski device 802 in accordance with one embodiment. The system 800 may include an interface 804, one or more processors 806 executing instructions stored on memory 808, a propulsion device 810, a controller 812, and a battery 814. As discussed previously, the battery 814 may be separate from components of the drivetrain, such as positioned toward the front of the ski device 802. One or more of these components may be in communication with one or more user devices 816 over one or more networks 818.

The processor(s) 806 may be any hardware device capable of executing instructions stored on memory 808 to provide various components or modules. The processor 806 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 806 may be configured as part of the ski device 802, the user device 816, or located at some remote location.

The memory 808 may be L1, L2, L3 cache, or RAM memory configurations. The memory 808 may include non-volatile memory such as flash memory, EPROM, EEPROM, ROM, and PROM, or volatile memory such as static or dynamic RAM, as discussed above. The exact configuration/type of memory 808 may of course vary as long as instructions for operating the ski device 802 can be performed by the system 800.

The network(s) 818 may link the various components with various types of network connections. The network(s) 818 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 818 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The user device 816 may refer to a handheld device operable by a user, such as the user of the ski device 802. The user device 816 may include an input/output (I/O) device 820, an interface 822 for receiving and transmitting data, and one or more sensors 824.

The user device 816 may be a single handheld device 816 which may control one or both ski devices used by a user. That is, one device 816 may send commands to both ski devices, or two devices 816 may be used in which each device 816 controls a specific ski device. The user device 816 may be connected or part of to a larger component such as a ski pole, glove, smart phone, smart glasses, the base of the ski device 802, a backpack, etc.

The user device 816 may use electromagnetic waves to communicate with receivers in the interface 804 to transfer data to the processor 806. Additionally or alternatively, the user device 816 may use direct wired connections. Input may also come from other sources such as voice input or even connections to other mobile devices, computers, or servers.

The sensor(s) 824 may gather data regarding the surrounding environment (i.e., the environment in which a user is using the ski device(s) 802). The sensor(s) 824 may be collocated with the user device 816, on the ski device(s) 802, on or with ski poles, boots, gloves or other clothing equipment, or any other location in which they can gather data regarding the surrounding environment.

In some embodiments, a motor of the drivetrain may be configured with a Hall effect sensor. Readings from the Hall effect sensor may be indicative of slippage or otherwise how well the track is engaging the ground surface. If the processor(s) 806 detect slippage, the controller 812 may engage a traction control procedure to, for example, slow the speed of the slipping wheel.

The processor(s) 806 may analyze the gathered environmental data and issue commands to the controller 812 to control the propulsion device 810. Accordingly, the ski device(s) 802 described herein may provide an intuitive experience for the user based on environmental factors.

For example, the sensor(s) 824 may include a thermometer for detecting temperatures associated with the environment. If the temperature is low (e.g., below some threshold), the system 800 may presume the ski device 802 may encounter ice or snow that is hard or otherwise frozen such that it is difficult for the track to achieve an appropriate grip therewith. In this situation, the controller 812 may issue a command to the propulsion device 810 to operate the track at a slow speed.

Additionally, a database 826 may store data regarding user preferences, the user's equipment, or the like. For example, a user may input via the I/O device 820 data regarding the type of track they are using, the time and date they last replaced the track, the user's weight, etc. The processor(s) 806 may leverage this data, along with data regarding the power level of the battery 814, usage level of the ski device 802 and components thereof, expected lifetime of components of the ski device 802, or the like, in controlling the propulsion device 810.

The processor(s) 806 may also communicate messages to the user via the I/O device 820. These messages may include suggestions for operating the ski device, suggestions to replace components, suggestions to charge the battery 814, or the like. These messages may visual (such as via a screen on a smartphone), auditory, haptic-based, or some combination thereof.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. For example, two blocks shown in succession may in fact be executed substantially concurrent or the blocks may sometimes be executed in the reverse order, depending upon the functionality/acts involved. Additionally, or alternatively, not all of the blocks shown in any diagram need to be included and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A drivetrain for a ski device, the drivetrain comprising:
a track configured to contact a ground surface;
a propulsion device configured to operate the track to at least propel the ski device;
a static component configured to be operably connected to the ski device; and
a dynamic component pivotally attached to the static component and configured to apply a variable force on the endless track to provide variable traction with the ground surface.

2. The drivetrain of claim 1 wherein the dynamic component is biased against the ground surface.

3. The drivetrain of claim 1 further comprising a suspension component operably connected between the static component and the dynamic component.

4. The drivetrain of claim 3 further comprising an adjustment mechanism to adjust the suspension component to vary an amount of suspension of the drivetrain.

5. The drivetrain of claim 1 further comprising a controller configured to:
receive a signal, and
modulate an output from the propulsion device to control the track.

6. The drivetrain of claim 5 wherein the signal is received wirelessly.

7. The drivetrain of claim 5 wherein the signal is received via a wired connection.

8. The drivetrain of claim 5 further comprising at least one sensor configured to gather environmental data, wherein the controller is further configured to modulate the output from the propulsion device based on the environmental data.

9. The drivetrain of claim 1 further comprising a release mechanism to enable the drivetrain to be removably attached to the ski device.

10. The drivetrain of claim 1 wherein the drivetrain is operational while propelling the ski device, and idle or in a brake mode when the ski device is not propelled.

11. The drivetrain of claim 1 further comprising at least two wheels, wherein at least one of the at least two wheels is in operable connectivity with the track and the propulsion device.

12. The drivetrain of claim 11 wherein power from the propulsion device is transferred to at least one driving wheel using a belt or chain drive, a hub motor within the wheel, a gear-driven system, or a directly-driven axle.

13. The drivetrain of claim 1 further comprising a motor, wherein the controller includes an Electronic Speed Controller or a motor controller.

14. The drivetrain of claim 1 wherein the track further includes a hyfax subsystem.

15. A system for operating a ski device, the system comprising:
at least one sensor configured to gather environmental data associated with the ski device;
a drivetrain operably connected with the ski device and configured to propel the ski device; and
a processor executing instructions stored on memory and configured to:
analyze the environmental data, and
control the drivetrain to propel or brake the ski device based on the analysis of the environmental data.

16. The system of claim 15 wherein the drivetrain includes a static component operably connected to the ski device and a dynamic component pivotally attached to the static component and configured to apply a variable force on the track to provide variable traction with a ground surface.

17. The system of claim 16 wherein the dynamic component is biased against the ground surface.

18. The system of claim 15 further comprising a suspension component operably connected between the static component and the dynamic component.

19. The system of claim 18 further comprising an adjustment mechanism to adjust the suspension component to control an amount of suspension.

20. The system of claim 15 further comprising at least two wheels, wherein at least one of the at least two wheels is in operable connectivity with the track and a propulsion device.
